(19) United States
(12) Patent Application Publication
(10) Pub. No.: US 2024/0075475 A1
(43) Pub. Date: Mar. 7, 2024

(54) OPTOELECTROFLUIDIC DEVICE FOR MASSIVE PARALLEL TRAPPING AND ENHANCED SPECTROSCOPY OF SINGLE NANOSCALE OBJECTS

(71) Applicant: Vanderbilt University, Nashville, TN (US)

(72) Inventors: Justus C. Ndukaife, Nashville, TN (US); Chuchuan Hong, Nashville, TN (US)

(21) Appl. No.: 18/454,285

(22) Filed: Aug. 23, 2023

Related U.S. Application Data
(60) Provisional application No. 63/400,321, filed on Aug. 23, 2022.
(60) Provisional application No. 63/486,697, filed on Feb. 24, 2023.

(51) Int. Cl. B01L 3/00; G01N 1/02

(52) U.S. Cl. CPC B01L 3/502761; G01N 1/02; B01L 2200/0652; B01L 2300/0654; B01L 2400/0415

(57) ABSTRACT

A nanotweezer includes a first electrode, a second electrode including a central region surrounded by a plurality of nanoholes, a fluidic chamber between the first electrode and the second electrode, and a voltage source configured to generate an electric field between the first electrode and the second electrode.

### RELATED APPLICATIONS

This application claims the benefit of U.S. Provisional Patent Application No. 63/400,321, filed Aug. 23, 2022, and U.S. Provisional Patent Application No. 63/486,697, filed Feb. 24, 2023. The entire contents of the applications referenced above are incorporated herein by reference.

### STATEMENT REGARDING FEDERALLY SPONSORED RESEARCH

This invention was made with government support under ECCS 2143836 awarded by the National Science Foundation. The government has certain rights in the invention.

### FIELD

The present disclosure relates to nanotweezers for manipulating nanoscale objects and, more particularly, to nanotweezers that manipulate nanoscale objects using electrohydrodynamic forces.

### BACKGROUND

Nanoscale extracellular vesicles are small membrane-bound vesicles released by cells into the extracellular environment. Extracellular vesicles were once thought of as a means for cells to expel wastes but have recently generated substantial scientific interest because they play a critical role in intercellular communication and contain important biological molecules including proteins, lipids, and nucleic acids. Extracellular vesicles are heterogeneous in size, biogenesis, and molecular composition. Examples of extracellular vesicles include exosomes (which are typically 30-150 nanometers in diameter and are derived from multivesicular bodies that mature and attach to the cell membrane for release), ectosomes (which are derived from an outward budding of cell membranes), exomeres, and supermeres (which are only about 25 nanometers in size). However, studying extracellular vesicles is challenging for a variety of technical reasons.

The nanoscale size of extracellular vesicles means that they are technically challenging to trap using conventional methods. For example, optical tweezers have been effective in trapping micrometer-scale particles, but as the size of the particle decreases into the nanoscale range, the technical challenges increase. Optical tweezers use a tightly focused laser beam to generate strong gradient forces on microscopic objects to trap the objects at the point of focus of the beam. However, the precision of the point of focus—and thus the precision with which objects can be trapped and manipulated—is limited by the diffraction limit of light (about 300 nanometers for visible light, for example). Thus, optical tweezers have poor resolution in trapping nanoscale particles such as extracellular vesicles.

Near-field optical nanotweezers based on plasmonic cavities use plasmon-enhanced optical trapping to confine light to the nanoscale to generate tight trapping potentials. The plasmonic cavities efficiently couple to propagate light to generate a highly enhanced and spatially confined electromagnetic field well below the diffraction limit of light. However, plasmonic tweezers rely on Brownian diffusion to load the trap, which can be slow, non-deterministic, and highly time consuming. Thus, plasmonic tweezers tend to have limited throughput and are not able to provide for the rapid delivery and trapping of particles at plasmonic hotspots while precluding the intrinsic plasmon-induced photothermal heating effect at the same time, which can make plasmonic tweezers impractical for low-particle-concentration solutions.

Electrothermoplasmonic tweezers harness plasmonic heating with an applied alternating current electric field to induce electrothermoplasmonic flow for the transport of particles towards the plasmonic cavity. This enables the trapping of particles at an illuminated plasmonic nanostructure. However, the electrothermoplasmonic approach requires plasmonic heating to transport particles to the electromagnetic hotspot, which is also the local of the thermal hotspot. Because the particles are trapped at the thermal hotspot, electrothermoplasmonic tweezers pose a risk of photothermal damage to delicate biological specimens such as extracellular vesicles. Furthermore, because the electrothermoplasmonic approach requires local plasmon-induced temperature rises to induce electrothermoplasmonic flow, dissipating the photothermal heating—for example, by using a high-thermal-conductivity substrate such as a heat sink—would mean that the electrothermoplasmonic flow is also reduced or eliminated, meaning that particles will no longer be transported to a trapping site.

These previously described approaches may not be suitable for achieving the fast transport of individual nanosized objects for stable trapping without also inducing potentially harmful photothermal heating at the trapping spot. Thus, these approaches may not be suitable for trapping heterogeneous populations of nanosized biological objects like extracellular vesicles so that they can be analyzed—for example, by scientific instruments that perform spectroscopy and/or microscopy on the trapped extracellular vesicles.

### SUMMARY

Examples of nanotweezers described herein overcome the previously described technical problems to enable the rapid and massive parallel trapping of individual nanosized objects—such as nanoscale extracellular vesicles—without generating potentially damaging levels of heat at the trapping site. Embodiments of nanotweezers described herein include geometry-induced electrohydrodynamic tweezers that may—in some examples—generate multiple electrohydrodynamic potentials for the parallelized transport and trapping of individual extracellular vesicles within seconds while also enhancing the imaging of the trapped extracellular vesicles. In various implementations, the nanotweezers described herein include nanoscale plasmonic cavities at the center of each geometry-induced electrohydrodynamic tweezer trap, which allows for the parallel placement of individual extracellular vesicles near plasmonic cavities to enable the instantaneous plasmon-enhanced optical trapping using laser illumination without any detrimental heating effects.

The nanotweezers described herein are also scalable. For example, any number of geometry-induced electrohydrodynamic tweezer traps may be fabricated on-chip via lithographic fabrication. Thus, hundreds, thousands, or even millions of individual nanoscale particles may be trapped at individual trap sites. Furthermore, some examples of nanotweezers described in this specification include individual plasmonic cavities at the centers of the geometry-induced electrohydrodynamic tweezer traps. These plasmonic cavities may work in a synergistic manner with the electrohydrodynamic potential generated by the nanotweezers. For example, the electrohydrodynamic potential moves the nanoparticles to the vicinity of the plasmonic cavities, and the nanoparticles may be trapped at the plasmonic cavities after they are illuminated with a focused laser without detrimental photothermal heating.

Accordingly, nanotweezers described herein achieve previously unachievable technical effects by allowing for high-throughput tether-free plasmon-enhanced trapping of individual extracellular vesicles. Furthermore, nanotweezers described in this specification allow for the fast parallelized trapping of multiple nanoparticles, reducing a trapping and spectroscopy process from an hour or more to seconds—all at a single particle resolution without the risk of photothermal damage. These technical effects provide technical capabilities for studying large populations of extracellular vesicles at an individual level. For example, the size and/or molecular composition of individual extracellular vesicles may be analyzed using scientific instruments such as spectrometers. Furthermore, given the ability to isolate large numbers (even millions) of nanoparticles in parallel within seconds, nanotweezers described in this specification greatly increase the throughput of any analysis system.

The technical improvements achieved by nanotweezers described herein scale across a variety of disciplines that benefit from the ability of quickly trapping massive numbers of individual nanoparticles at a single nanoparticle resolution—such as the study and characterization of nanoplastics and/or scalable hybrid integration for quantum photonics.

A nanotweezer includes a first electrode, a second electrode including a central region surrounded by a plurality of nanoholes, a fluidic chamber between the first electrode and the second electrode, and a voltage source configured to generate an electric field between the first electrode and the second electrode.

In other features, the plurality of nanoholes includes a circular array of nanoholes surrounding the central region. In other features, the circular array of nanoholes includes nanoholes arranged in concentric circles around the central region. In other features, the plurality of nanoholes includes a square array of nanoholes surrounding the circular array of nanoholes. In other features, the nanotweezer further includes a plasmonic nanocavity formed through the central region and a light source configured to illuminate the plasmonic nanocavity with a coherent focused light beam.

In other features, the voltage source is configured to stop generating the electric field after the light source illuminates the plasmonic nanocavity with the coherent focused light beam. In other features, the voltage source is configured to reduce a frequency of the electric field after the light source illuminates the plasmonic nanocavity with the coherent focused light beam. In other features, the light source is configured to stop illuminating the plasmonic nanocavity with the coherent light beam after the voltage source reduces the frequency of the electric field and the voltage source is configured to stop generating the electric field after the light source stops illuminating the plasmonic nanocavity with the coherent light beam.

In other features, the voltage source is configured to switch the electric field from an alternating current electric field to a direct current electric field after the light source illuminates the plasmonic nanocavity with the coherent focused light beam. In other features, the second electrode includes a plurality of central regions surrounded by a plurality of nanoholes, each central region is surrounded by a first plurality of nanoholes arranged in concentric circles around each central region, and a second plurality of nanoholes is arranged in a square array around the first plurality of nanoholes.

A method of operating a nanotweezer includes generating an electric field between a first electrode and a second electrode. The second electrode includes a central region surrounded by a plurality of nanoholes. A fluidic chamber is defined between the first electrode and the second electrode.

In other features, the plurality of nanoholes includes a circular array of nanoholes surrounding the central regions. In other features, the circular array of nanoholes includes nanoholes arranged in concentric circles around the central region. In other features, the plurality of nanoholes includes a square array of nanoholes surrounding the circular array of nanoholes. In other features, the method includes illuminating a plasmonic nanocavity formed through the central region with a coherent focused light beam. In other features, the method includes stopping the generation of the electric field after illuminating the plasmonic nanocavity with the coherent focused light beam.

In other features, the method includes reducing a frequency of the electric field after illuminating the plasmonic nanocavity with the coherent focused light beam. In other features, the method includes stopping the illumination of the plasmonic nanocavity with the coherent light beam after reducing the frequency of electric field and stopping the generation of the electric field after stopping the illumination of the plasmonic nanocavity with the coherent light beam.

In other features, the method includes switching the electric field from an alternating current electric field to a direct current electric field after illuminating the plasmonic nanocavity with the coherent focused light beam. In other features, the second electrode includes a plurality of central regions surrounded by a plurality of nanoholes, each central region is surrounded by a first plurality of nanoholes arranged in concentric circles around each central region, and a second plurality of nanoholes is arranged in a square array around the first plurality of nanoholes.

Other examples, embodiments, features, and aspects will become apparent by consideration of the detailed description and accompanying drawings.

### BRIEF DESCRIPTION OF THE DRAWINGS

FIG. 1 is a block diagram of an example system for trapping and analyzing nanoscale particles.

FIGS. 2A-2B are cross-sectional views of example nanotweezer devices.

FIG. 3 is a top view of an example electrode of a nanotweezer device.

FIG. 4 is a top view of an example electrode of a nanotweezer device.

FIG. 5 is a top view of an example electrode of a nanotweezer device.

FIG. 6 is a cross-sectional view of a nanotweezer device showing a trapped nanoparticle.

FIG. 7 is a scanning electron microscope image of a top view of an example electrode of a nanotweezer device.

FIGS. 8A-8B are cross-sectional views of example nanotweezer devices.

FIG. 9 is a top view of an electrode of a nanotweezer device.

FIG. 10 is a cross-sectional view of a nanotweezer device showing a trapped nanoparticle according to the present disclosure.

FIG. 11 shows scanning electron microscope images of top views of example electrodes of a nanotweezer device that include plasmonic cavities.

FIGS. 12A-12B are flowcharts of an example process for a controlling waveform generator and/or a laser generator to trap nanoparticles using a nanotweezer device.

FIG. 13 shows the dynamic manipulation and immobilization of a single nanoparticle between plasmonic cavities.

FIGS. 14A-14B are flowcharts of an example process for manufacturing a nanotweezer device.

FIG. 15 illustrates frame-by-frame sequences of trapping of nanoparticles at various AC frequencies.

FIG. 16 illustrates the behavior of nanoparticles trapped in parallel across an example implementation of nanotweezer device.

FIG. 17 illustrates behaviors of trapped nanoparticles in response to AC electric fields being generated at nanotweezer device and plasmonic cavities being illuminated with a laser beam.

In the drawings, reference numbers may be reused to identify similar and/or identical elements.

### DETAILED DESCRIPTION

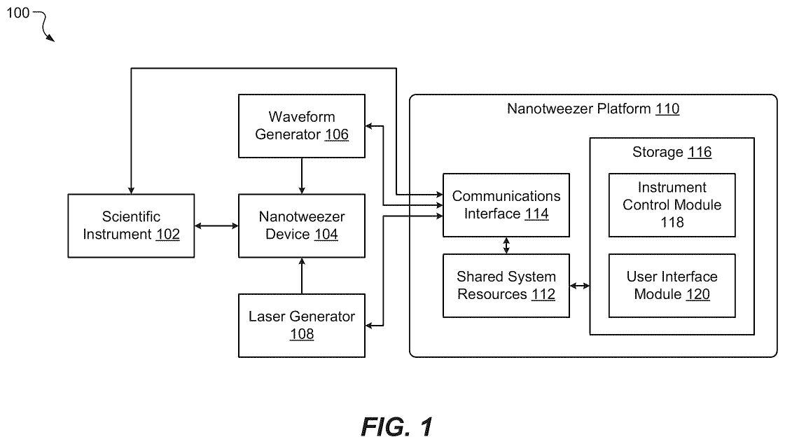

FIG. 1 is a block diagram of an example system 100 for trapping and analyzing nanoscale particles. As shown in FIG. 1, system 100 may include one or more instruments for analyzing the nanoscale particles, such as scientific instrument 102, a nanotweezer device 104 for trapping and/or isolating one or more nanoscale particles, a waveform generator 106 for generating electric fields at the nanotweezer device 104, and a light source such as laser generator 108 for illuminating one or more areas of nanotweezer device 104 with one or more coherent focused light beams such as one or more lasers. System 100 may also include one or more computing platforms for controlling scientific instrument 102, waveform generator 106, and/or laser generator 108, such as nanotweezer platform 110.

In various implementations, scientific instrument 102 includes one or more spectrometers, such as a mass spectrometer, a UV-visible spectrophotometer, an infrared spectrometer, a nuclear magnetic resonance spectrometer, a fluorescence spectrophotometer, a Raman spectrometer, an x-ray spectrometer, a gamma spectrometer, an electron spin resonance spectrometer, an atomic absorption spectrometer, an atomic emission spectrometer, a time-resolved spectroscopy instrument, a photoacoustic spectrometer, and/or a photothermal spectrometer.

In some embodiments, scientific instrument 102 includes one or more microscopes. Suitable examples of microscopes include optical microscopes (such as compound microscopes, stereo microscopes, phase contrast microscopes, darkfield microscopes, confocal microscopes, and/or fluorescence microscopes), electron microscopes (such as transmission electron microscopes and/or scanning electron microscopes), scanning probe microscopes (such as atomic force microscopes and/or scanning tunneling microscopes, digital microscopes (such as digital microscopes based on optical and/or electron microscopy principles), x-ray microscopes, and/or near-field scanning optical microscopes.

In some embodiments, waveform generator 106 produces AC and/or DC outputs. For example, waveform generator 106 may be capable of generating one or more waveform shapes (such as sine waves, square waves, triangular waves, and/or sawtooth waves) across a range of frequencies. In some examples, waveform generator 106 produces AC outputs having frequencies spanning from low frequencies (for example, about 1 hertz to about 100 hertz) to high frequencies (3 gigahertz and beyond). In various implementations, waveform generator 106 produces AC outputs having frequencies in a range of between about 2 kilohertz to about 10 kilohertz. In some embodiments, the waveform generator 106 includes a dual-channel function generator such as the Model 4047B 20 MHz Dual Channel Function/Arbitrary Generator available from B&K Precision Corporation. In some examples, laser generator 108 emits continuous wave and/or pulse wave laser light in the near infrared (for example, wavelengths in a range of between about 800 nanometers and about 2,500 nanometers) and/or visible (for example, wavelengths in a range of between about 380 nanometers and about 700 nanometers) spectrums. In some embodiments, laser generator 108 includes a 973-nanometer semiconductor diode laser such as the CLD1015 laser available from Thorlabs, Inc. The laser may be focused with a lens such as a 40× objective lens having a numerical aperture value of 0.75.

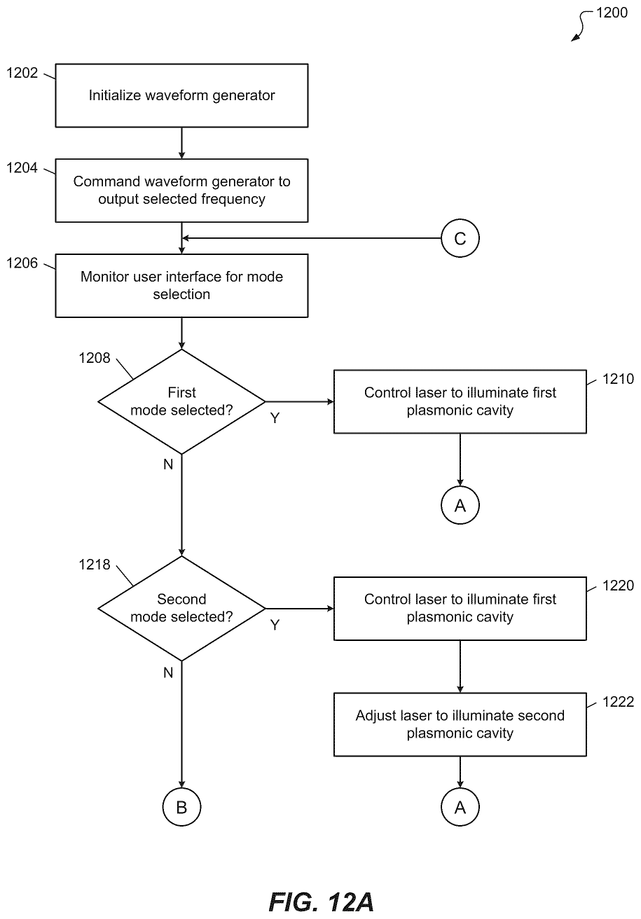

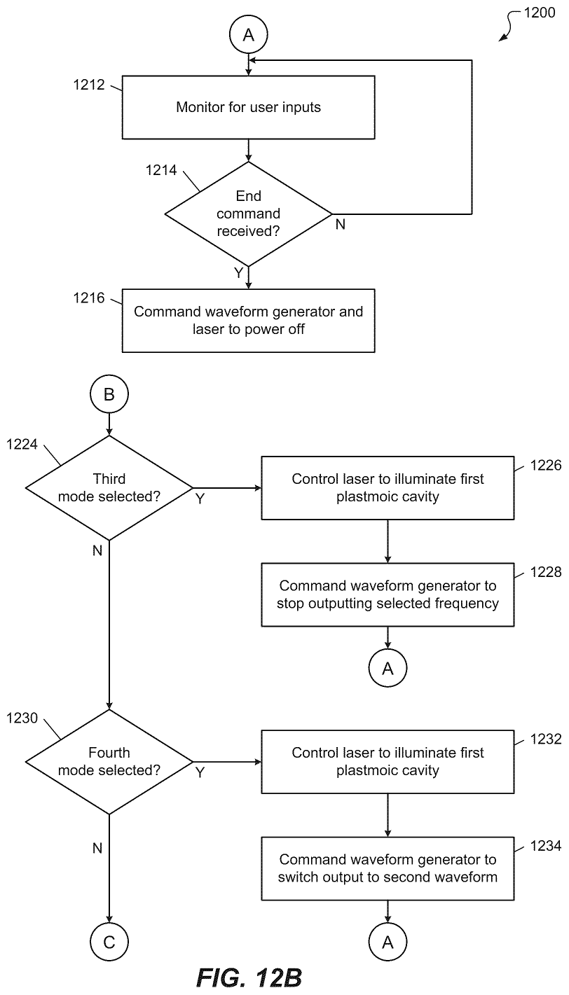

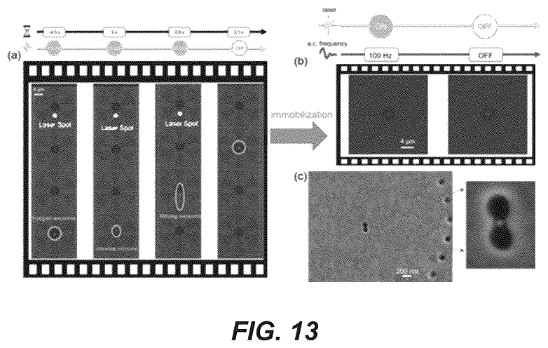

As shown in FIG. 1, some examples of nanotweezer platform 110 include shared system resources 112, communications interface 114, and/or one or more data stores that include non-transitory computer-readable storage media, such as storage 116. In some implementations, the shared system resources 112 include one or more electronic processors, one or more graphics processing units, volatile computer memory, non-volatile computer memory, and/or one or more system buses connecting the components of the shared system resources 112, communications interface 114, and/or storage 116. In various implementations, storage 116 includes one or more software modules, such as instrument control module 118 and/or user interface module 120. In some examples, instrument control module 118 controls scientific instrument 102, waveform generator 106, and/or laser generator 108. In some embodiments, user interface module 120 generates a user interface for users to interact with system 100. Additional functionality of instrument control module 118 and user interface module 120 will be described below with reference to FIGS. 12A-12B. In various implementations, nanotweezer platform 110 is operatively coupled to and communicates with scientific instrument 102, waveform generator 106, and/or laser generator 108 via communications interface 114.

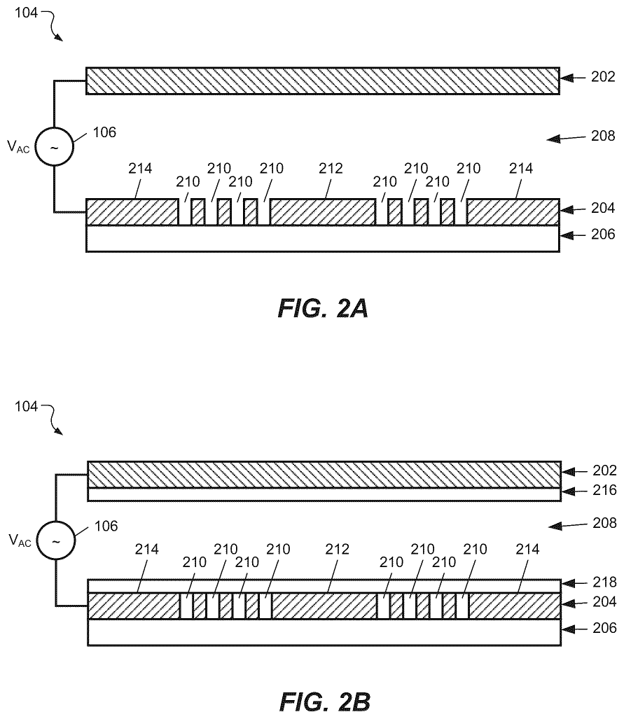

FIGS. 2A-2B are cross-sectional views of example nanotweezer devices 104. As shown in FIG. 2A, some examples of nanotweezer device 104 include a first electrode 202, a second electrode, and a substrate layer 206. In various implementations, first electrode 202 may include a substantially planar structure having a thickness that is formed of a conductive material. For example, first electrode 202 may be formed of a substantially transparent metal such as indium tin oxide. In some embodiments, first electrode 202 may be formed of any combination of conductive materials, such as one or more of gold, platinum, silver, titanium, aluminum, tungsten, nickel titanium alloys, zirconium nitride, carbon-based materials (such as graphene and other conductive carbon films and/or carbon nanotubes), and/or conductive polymers (such as polyaniline, polypyrrole, and/or poly(3,4-ethylenedioxythiopene) polystyrene sulfonate).

In various implementations, second electrode 204 includes a substantially planar structure having a thickness, such as a conductive film layer. In some examples, second electrode 204 includes a conductive film layer deposited on substrate layer 206. In various implementations, second electrode 204 has a thickness of about 120 nm. Accordingly to some embodiments, second electrode 204 is formed of any combination of conductive materials, such as gold, platinum, silver, titanium, aluminum, tungsten, nickel titanium alloys, zirconium nitride, indium tin oxide, carbon-based materials (such as graphene and other conductive carbon films and/or carbon nanotubes), and/or conductive polymers (such as polyaniline, polypyrrole, and/or poly(3,4-ethylenedioxythiopene) polystyrene sulfonate). In some embodiments, substrate layer 206 is formed of a glass and/or sapphire material.

As shown in FIG. 2A, nanotweezer device 104 may include a fluidic chamber 208 defined between the first electrode 202 and the second electrode 204. Samples—such as fluids containing nanoparticles—may be introduced into fluidic chamber 208 for trapping by nanotweezer device 104. Second electrode 204 may include a plurality of nanoholes 210 arranged in a circular geometry around a central region 212. In various implementations, one or more of the nanoholes 210 has a diameter of about 160 nanometers. In some examples, one or more of the nanoholes 210 has a depth of about 120 nanometers. In some embodiments, one or more of the central regions 212 has a diameter in a range of between about 4 micrometers to about 25 micrometers. In some implementations, second electrode 204 includes an outer region 214 surrounding the plurality of nanoholes 210. In various implementations, waveform generator 106 is electrically coupled to both first electrode 202 and second electrode 204 and generate electric fields between the first electrode 202 and the second electrode 204.

As shown in FIG. 2B, some examples of nanotweezer device 104 include a first cover layer 216 and/or a second cover layer 218. In various implementations, a side of first electrode 202 facing second electrode 204 is covered by first cover layer 216. In some embodiments, a side of second electrode 204 facing first electrode 202 is covered by second cover layer 218. In various implementations, first cover layer 216 and/or second cover layer 218 are formed of a substantially dielectric material, such as glass and/or sapphire. In some examples, first cover layer 216 and/or second cover layer 218 are formed of an indium-tin-oxide-coated glass material spaced by a 120-micrometer thick spacer to create microfluidic channels around the patterns formed by nanoholes 210. Covering first electrode 202 and/or second electrode 204 with dielectric layers may prevent direct electrical contact between first electrode 202 and/or second electrode 204 and the sample in fluidic chamber 208.

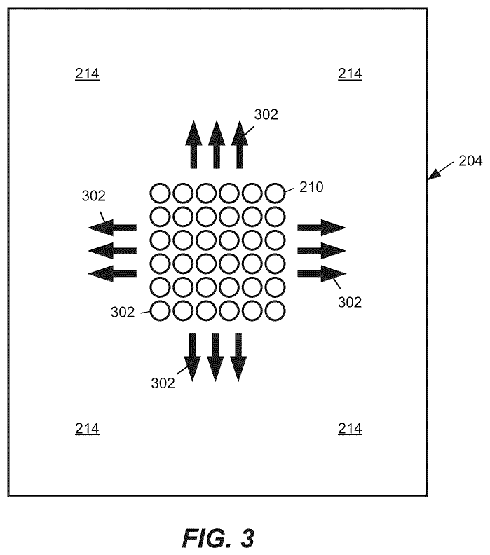

FIG. 3 is a top view of an example second electrode 204. As shown in FIG. 3, some examples of second electrode 204 include a square array of nanoholes 210. Waveform generator 106 may generate an electric field between first electrode 202 and second electrode 204 in a direction perpendicular to the second electrode 204. The square array of nanoholes 210 distorts the AC electric field lines, which gives rise to normal and tangential AC electric fields. The tangential component of the AC electric field exerts Coulombic forces 302 on the diffuse charges in the electrical double layer induced at the interface between array of nanoholes 210 and the fluid in the fluidic chamber 208, which transports any suspended nanoparticles in the fluidic chamber 208 radially away from the edges of the array of nanoholes 210. In some embodiments, waveform generator 106 applies the AC field in a direction parallel to the surface of second electrode 204.

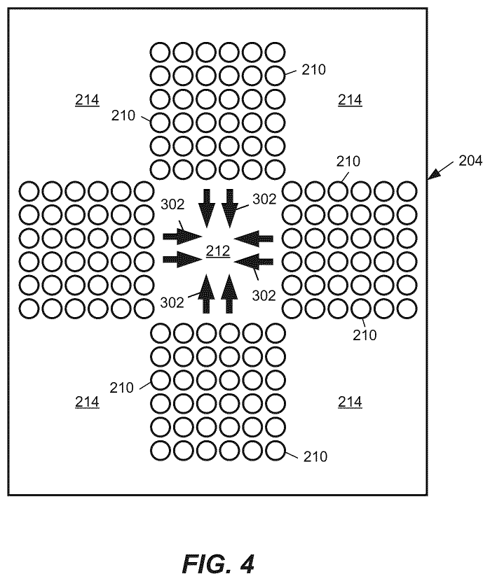

FIG. 4 is a top view of an example second electrode 204. As shown in FIG. 4, some examples of second electrode 204 include three additional square arrays of nanoholes 210 placed adjacent to one another to form a substantially square central region 212 between the square arrays of nanoholes 210. As shown in the example of FIG. 4, the substantially square central region 212 does not include nanoholes 210. As shown in the example of FIG. 4, after waveform generator 106 applies the electric field between first electrode 202 and second electrode 204, the Coulombic forces 302 will create an electroosmotic flow away from edges of each square array of nanoholes 210, which results in a stagnation zone at the center of square central region 212.

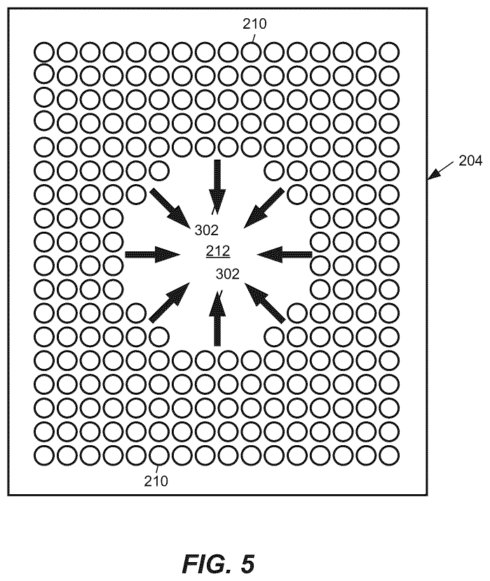

FIG. 5 is a top view of an example second electrode 204. As shown in FIG. 4, nanoholes 210 may be formed as a square array with circular central regions 212 that do not include nanoholes 210. As illustrated in FIG. 5, after waveform generator 106 applies the electric field between first electrode 202 and second electrode 204, the Coulombic forces 302 create an electroosmotic flow in directions perpendicular to and away from the border of the array of nanoholes 210 around circular central region 212, which results in a stagnation zone at the center of circular central region 212. The center of the square central region 212 and/or the center of the circular central region 212 define a position in a plane substantially parallel to the surface of second electrode 204 where an individual nanoparticle will be readily trapped by electrohydrodynamic potential.

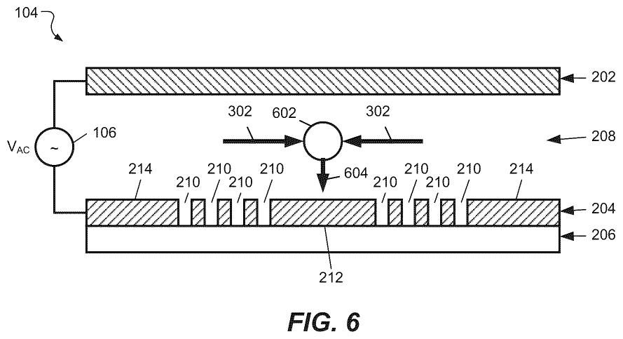

FIG. 6 is a cross-sectional view of a nanotweezer device 104 showing a trapped nanoparticle 602. As illustrated in FIG. 6, the position of the trapped nanoparticle 602 in a direction normal to the surface of the second electrode 204 (e.g., a position between first electrode 202 and second electrode 204) may be determined by the particle-surface interaction force 604 that arises from the interaction between the double layer charge on the particle and its image charge on the conduction plane (e.g., the second electrode 204). Thus, each central region 212 may be referred to as a nanoparticle trap or a geometry-induced electrohydrodynamic tweezer trap.

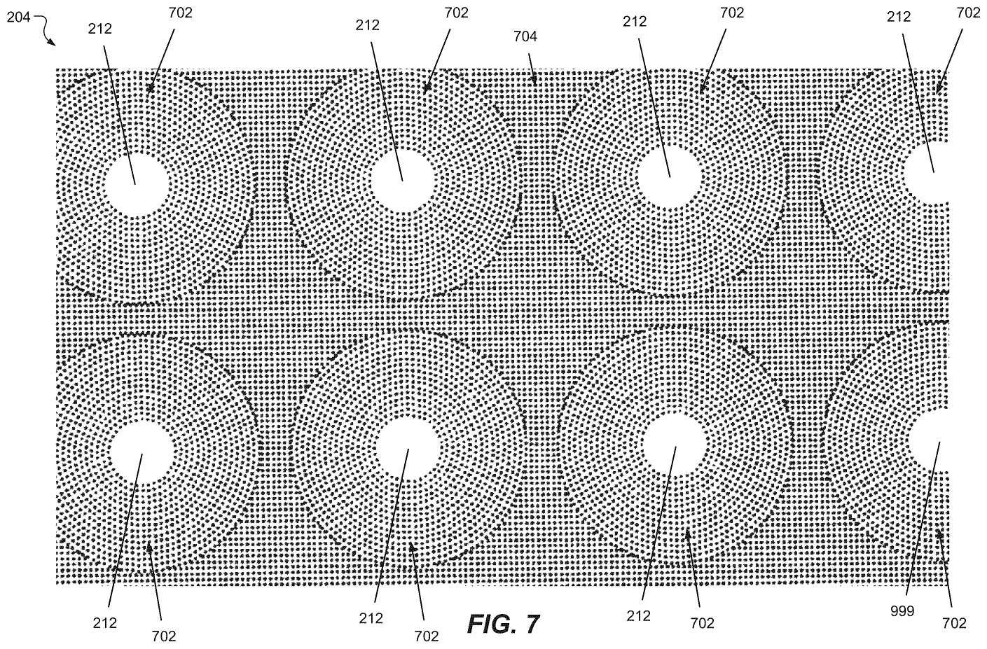

FIG. 7 is a scanning electron microscope image of a top view of an example second electrode 204. As shown in FIG. 7, the number of traps formed by central regions 212 may be scalable to any number of traps. For example, while FIG. 7 shows eight traps formed by eight central regions 212 for trapping eight individual nanoparticles, second electrode 204 may include any number of central regions 212 for trapping any number of individual nanoparticles. In various implementations, second electrode 204 may include one or more circular arrays of nanoholes 702 surrounding one or more central regions 212. Each circular array of nanoholes 702 includes a plurality of nanoholes 210 arranged in concentric rings around a central region 212. The concentric rings radiate outwardly from central region 212 such that each subsequent concentric ring has a greater diameter than a previous concentric ring. In some embodiments, second electrode 204 includes a square array of nanoholes 704 between the circular arrays of nanoholes 702.

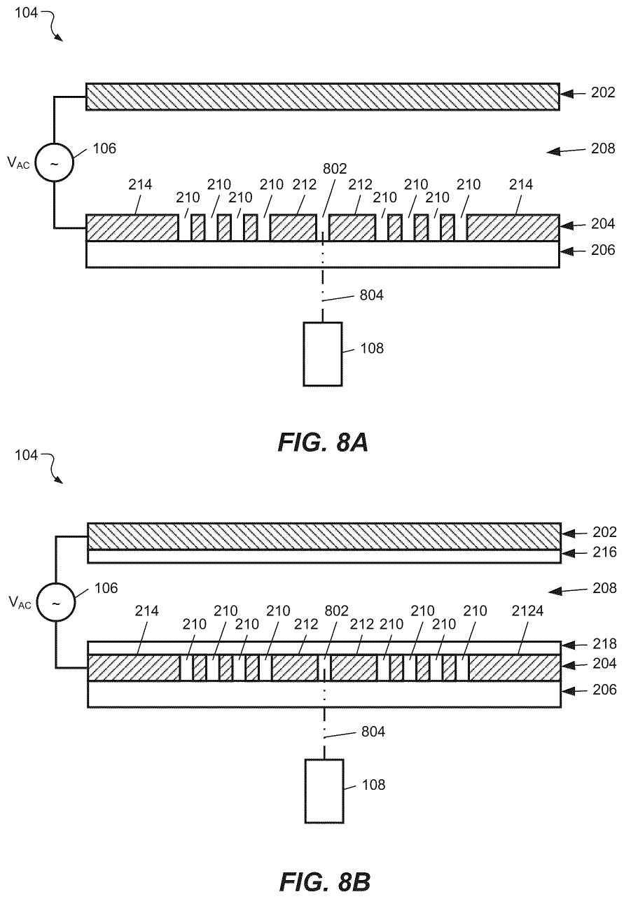

FIGS. 8A-8B are cross-sectional views of nanotweezer devices 104. As shown in FIGS. 8A-8B, some examples of the nanotweezer device 104 include a plasmonic cavity 802 formed through one or more of the central regions 212. Laser generator 108 may emit a laser 804 to illuminate the plasmonic cavity 802 to generate a plasmon-enhanced optical trapping potential. Upon illumination of any plasmonic cavity 802 by laser 804, the generated nearfield optical force precisely places a single nanoparticle 602 at the illuminated plasmonic cavity 802. In various implementations, laser generator 108 may emit a laser 804 having a power in a range of between about 6.3 milliwatts and about 25 milliwatts. In some implementations, substrate layer 206 may be formed of a sapphire material. Because the sapphire material has a higher thermal conductivity of about 25.2 watts per meter-kelvin (compared with about 1.38 watts per meter-kelvin for glass), examples where substrate layer 206 is formed of sapphire allows the substrate layer 206 to act as an effective heat sink to dissipate energy from laser 804. For example, laser generator 108 may emit a laser 804 having a power of about 6.3 milliwatts, which results in an incident intensity of about 3.2×10⁹ watts per square meter and a temperature rise of about 0.32 kelvin, which is negligible. The 6.3-milliwatt laser 804 generates a plasmon-enhanced optical trapping potential of about 1.8 k_{b}T on a nanoparticle having about a 100-nanometer diameter, which is sufficient to stably trap the nanoparticle.

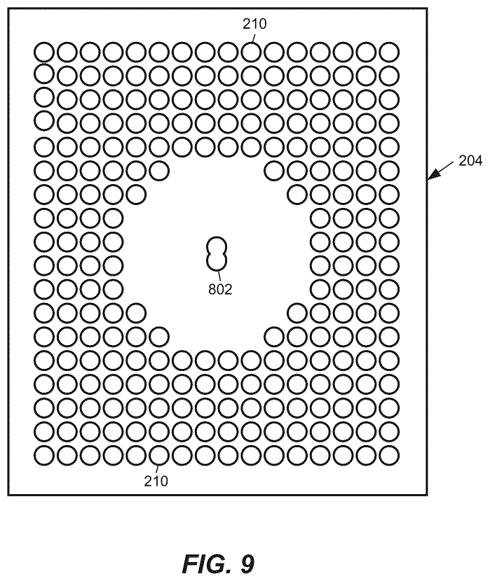

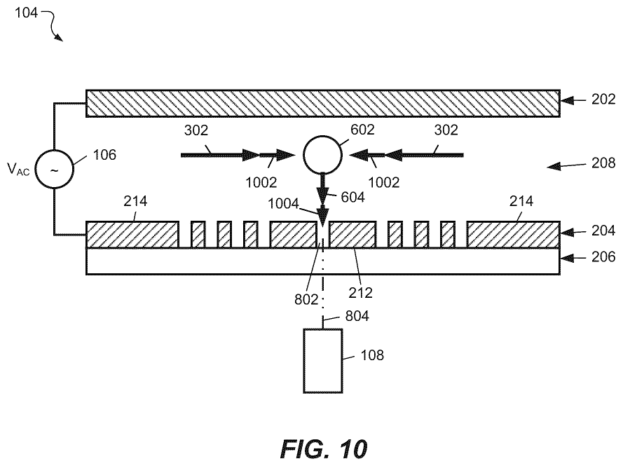

FIG. 9 is a top view of a second electrode 204. As illustrated in FIG. 9, in some implementations, plasmonic cavity 802 may be formed as a double nanohole aperture (e.g., two overlapping circular nanoholes). FIG. 10 is a cross-sectional view of a nanotweezer device 104 showing a trapped nanoparticle 602. As shown in FIG. 10, illuminating plasmonic cavity 802 with laser 804 generates radial optical gradient forces 1002 and vertical optical gradient forces 1004 that act to trap nanoparticle 602 at the illuminated plasmonic cavity 802, which may be co-located with the trap at the center of central region 212. Thus, a plasmon-enhanced optical trapping is imposed on top of the electrohydrodynamic trapping when laser generator 108 illuminates plasmonic cavity 802 with laser 804 at the same time waveform generator 106 applies the electric field between first electrode 202 and second electrode 204. This parallel trapping functions collectively to trap nanoparticle 602. In various implementations, (i) waveform generator 106 applies the electric field between first electrode 202 and second electrode 204 to trap nanoparticle 602 at the central region 212, (ii) laser generator 108 illuminates plasmonic cavity 802 with laser 804 to apply plasmon-enhanced optical trapping to nanoparticle 602, then (iii) waveform generator 106 may switch off or reduce the intensity of the electric field and the nanoparticle 602 remains securely trapped with the plasmon-enhanced optical trapping forces.

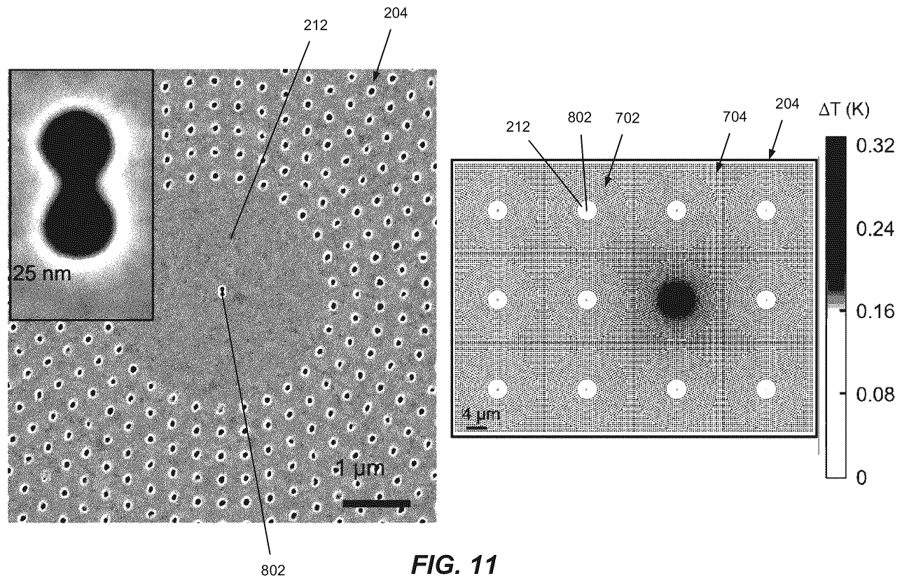

FIG. 11 shows scanning electron microscope images of top views of example second electrodes 204 that include plasmonic cavities 802. As shown on the left-side of FIG. 11, second electrode 204 may include plasmonic cavities 802 formed as two overlapping nanoholes. FIG. 11 also illustrates (on the right-side of the figure) a temperature field distribution at second electrode 204 when one of the plasmonic cavities 802 is illuminated with a 6.3-milliwatt laser. As shown in FIG. 11, such illumination only creates about a negligible 0.32 kelvin temperature gradient in examples where substrate layer 206 is formed of a sapphire material.

FIGS. 12A-12B are flowcharts of an example process 1200 for controlling waveform generator 106 and/or laser generator 108 to trap nanoparticles using nanotweezer device 104. At 1202, instrument control module 118 initializes waveform generator 106. For example, user interface module 120 generates a selectable user interface element allowing a user to initialize system 100. In response to the user selecting the selectable user interface element, instrument control module 118 initializes waveform generator 106. At 1204, instrument control module 118 commands waveform generator 106 to output a selected frequency. In various implementations, the selected frequency may be about 3.5 kilohertz to enable rapid parallel trapping of individual nanoparticles 602 at central regions 212. At 1206, instrument control module 118 and/or user interface module 120 monitors the user interface for the user to select an operating mode. For example, user interface module 120 generates a first selectable user interface element corresponding to a first operating mode, a second user interface element corresponding to a second operating mode, a third selectable user interface element corresponding to a third operating mode, and a fourth user interface element corresponding to a fourth operating mode.

In response to the user selecting the first user interface element corresponding to the first operating mode (“YES” at decision block 1208), instrument control module 118 controls the laser generator 108 to illuminate the a first plasmonic cavity 802 with the laser 804 and precisely position one of the nanoparticles 602 at the first plasmonic cavity 802 using the plasmon-enhanced optical force at 1210. The remaining nanoparticles 602 are held at other central regions 212 by electrohydrodynamic potentials. From block 1210, process 1200 proceeds to block 1212, where instrument control module 118 and/or user interface module 120 monitor the user interface for user inputs. In various implementations, user interface includes a selectable end element. In response to instrument control module 118 and/or user interface module 120 not detecting the user selecting the end element (“NO” at decision block 1214), process 1200 proceeds back to 1212. In response to instrument control module 118 and/or user interface module 120 detecting the user selecting the end element (“YES” at decision block 1214), process 1200 commands waveform generator 106 and laser generator 108 to power off, releasing trapped nanoparticles 602.

In response to instrument control module 118 and/or user interface module 120 not detecting the user selecting the first user interface element corresponding to the first operating mode (“NO” at decision block 1208), instrument control module 118 and/or user interface module 120 determine whether the user selected the second user interface element corresponding to the second operating mode at decision block 1218. In response to instrument control module 118 and/or user interface module 120 detecting that the user selected the second user interface element corresponding to the second operating mode (“YES” at decision block 1218), instrument control module 118 commands laser generator 108 to illuminate a first plasmonic cavity 802 with laser 804 to trap a first nanoparticle 602 with plasmonic-enhanced optical trapping at 1220. At 1222, instrument control module 118 commands laser generator 108 to adjust laser 804 to illuminate a second plasmonic cavity 802 to trap a second nanoparticle 602 with plasmonic-enhanced optical trapping. Process 1200 proceeds to block 1212.

In response to instrument control module 118 and/or user interface module 120 not detecting the user selecting the second user interface element corresponding to the second operating mode (“NO” at decision block 1208), instrument control module 118 and/or user interface module 120 determine whether the user selected the third user interface element corresponding to the third operating mode at decision block 1224. In response to instrument control module 118 and/or user interface module 120 detecting that the user selected the third user interface element corresponding to the third operating mode (“YES” at decision block 1224), instrument control module 118 commands laser generator 108 to illuminate a plasmonic cavity 802 with laser 804 at 1226. At 1228, instrument control module 118 commands waveform generator 106 to stop outputting the selected frequency (e.g., turn off the electric field). Process 1200 proceeds to 1212.

In response to the instrument control module 118 and/or user interface module 120 not detecting the user selecting the third user interface element corresponding to the third operating mode (“NO” at decision block 1224), instrument control module 118 and/or user interface module 120 determine whether the user selected the fourth user interface element corresponding to the fourth operating mode at decision block 1230. In response to instrument control module 118 and/or user interface module 120 detecting the user selecting the fourth user interface element corresponding to the fourth operating mode (“YES” at decision block 1230), instrument control module 118 commands laser generator 108 to illuminate a plasmonic cavity 802 with laser 804 at 1232. At 1234, instrument control module 118 commands waveform generator 106 to switch its output from a first waveform to a second waveform. In various implementations, the first waveform may be an AC waveform having a frequency of about 3.5 kilohertz. In some embodiments, the second waveform may be an AC waveform having a frequency of about 100 hertz. In some examples, the second waveform may be an AC waveform having a frequency in a range of between about 1 hertz to about 100 hertz. In various implementations, the second waveform may be a DC field. Process 1200 proceeds to 1212.

In response to instrument control module 118 and/or user interface module 120 not detecting the user selecting the fourth user interface element corresponding to the fourth operating mode (“NO” at decision block 1230), process 1200 proceeds back to 1206. In various implementations, the first operating mode and the second operating mode provide the means to harness the system 100 for both rapid high-stability near-field optical trapping at plasmonic hotspots (e.g., at plasmonic cavities 802) and plasmon-enhanced spectroscopies (such as surface-enhanced fluorescence and/or surface-enhanced Raman spectroscopy) of individual nanoparticles 602.

FIG. 13 shows the dynamic manipulation and immobilization of a single nanoparticle 602 between plasmonic cavities 802. Inset (a) of FIG. 13 shows a frame-by-frame sequence. As shown in the first frame, in some embodiments, instrument control module 118 commands laser generator 108 to dynamically reposition a trapped nanoparticle 602 from a first plasmonic cavity 802 to a different plasmonic cavity 802 by temporarily illuminating the nanohole array outside of central regions 212 (for example, at a circle array of nanoholes 702). In various implementations, the higher-powered laser 804 may have a power of about 25 milliwatts. The higher-powered laser 804 may increase the temperature rise from about 0.32 kelvin to about 8.44 kelvin at the second plasmonic cavity 802. In the presence of the AC field applied by waveform generator 106, this increased temperature rise at the second plasmonic cavity 802 induces a radially inward electrothermoplasmonic flow toward the second plasmonic cavity 802 that transports the trapped nanoparticle 602 towards the second plasmonic cavity (shown in the second and third frames). In various implementations, the higher-powered laser 804 may be switched off before the nanoparticle 602 reaches the second plasmonic cavity 802. In such a scenario, nanoparticle 602 will be drawn towards the nearest central region 212 (shown in the fourth frame).

Inset (b) of FIG. 13 shows the repositioned nanoparticle 602 being immobilized at a central region 212. For example, the AC electric field may be switched to a lower frequency (such as 100 hertz) in the first frame, which results in the repositioned nanoparticle 602 being pressed towards the surface of second electrode 204 by electrophoretic forces. After the laser is switched off in the second frame, van der Waals forces will keep the nanoparticle securely trapped at the plasmonic cavity 802, even when both the AC electric field and laser are removed (shown in scanning electron microscope image (c) of FIG. 13).

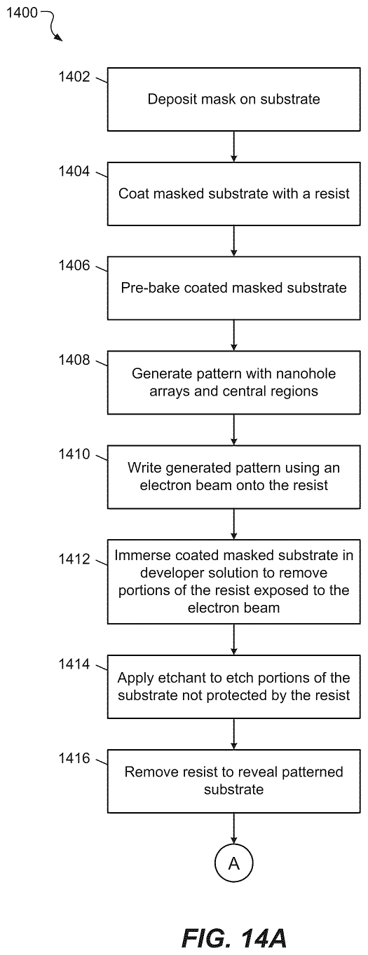

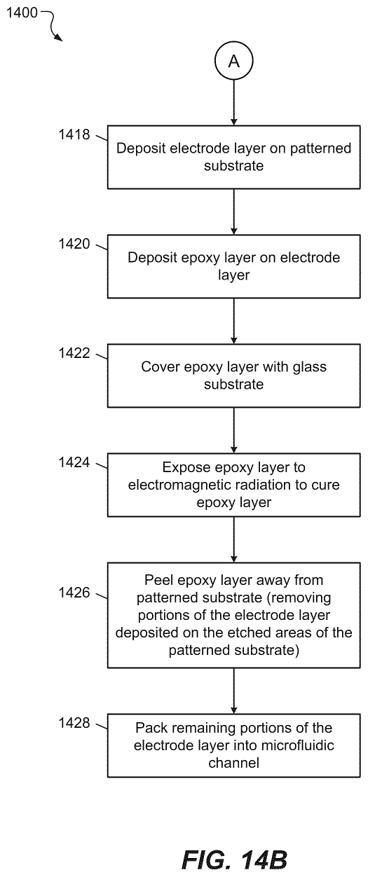

FIGS. 14A-14B are flowcharts of an example process 1300 for manufacturing a nanotweezer device 104. At 1402, a mask is deposited on a substrate. For example, a 10-nanometer thick chromium mask is deposited on a silicon wafer substrate using a thermal evaporator. At 1404, the masked substrate is coated with a resist. For example, the silicon wafer substrate with the chromium mask may be coated with a PMMA 950 A4 resist. At 1406, the coated masked substrate is pre-baked (for example, at 180° Celsius for two minutes). At 1408, a pattern with nanohole arrays and central regions is generated. At 1410, the generated pattern is written onto the resist using an electron beam (for example, using electron beam lithography). At 1412, the coated masked substrate is immersed in a developer solution to remove portions of the resist that were previously exposed to the electron beam at 1410. For example, the resist may be developed with MIBK/IPA 1:3 developer solution for about 35 seconds, rinsed with isopropyl alcohol, blown dry with nitrogen, and descummed for about 4 seconds.

At 1414, etchant is applied to etch portions of the substrate not protected by the resist. For example, chromium etchant may be applied for about 10 seconds to transfer the pattern onto the chromium layer serving as the hard mask for a subsequent reactive ion etching process. Reactive ion etching may be performed for about one minute to open about 500 nanometers deep nanoholes into the silicon wafer. At 1416, the resist is removed to reveal the patterned substrate. In various implementations, the patterned silicon wafer may be soaked in acetone for about 10 minutes, then soaked in chromium etchant for about 10 minutes. The patterned silicon wafer can now serve as a template. At 1418, an electrode layer is deposited on the patterned substrate. For example, a gold film layer having a thickness of about 120 nanometers is deposited on the template using an electron beam evaporation machine. At 1420, an epoxy layer is deposited on the electrode layer. For example, a UV-curable epoxy may be deposited on the gold film.

At 1422, the epoxy layer is covered with a glass substrate. For example, the UV-curable epoxy may be covered with an indium-tin-oxide-coated glass substrate. At 1424, the epoxy layer is exposed to electromagnetic radiation to cure the epoxy layer. In some examples, the UV-curable epoxy is exposed to UV light having about a 324-nanometer wavelength for about 20 minutes to harden the epoxy. At 1426, the epoxy layer is peeled away from the patterned substrate, removing portions of the electrode layer deposited on the etched areas of the patterned substrate. For example, the gold film is peeled off the silicon template. At 1428, the remaining portions of the electrode layer may be packed into a microfluid channel. For example, the gold film may be packed into a microfluidic channel.

In various implementations, the patterned substrate (e.g., the patterned silicon wafer template) may be reused by depositing another electrode layer on the patterned substrate at 1418. For example, the used silicon template may be cleaned using oxygen plasma etching and gold etchant. In some embodiments, focused ion beam milling may be used to drill plasmonic cavities directly on the gold film deposited on the sapphire substrate.

In various tests, trapping of fluorescently labelled CD63⁺ extracellular vesicles having diameters in a range of between about 30 nanometers and about 150 nanometers by system 100 has been demonstrated and confirmed using nanoparticle tracking analysis. Extracellular vesicles may be in solution and diluted to concentrations ranging from about 10⁴ particles per milliliter to about 10⁹ particles per milliliter. Additionally, trapping of nanoparticles 602 such as polystyrene beads having diameters of about 100 nanometers has been demonstrated. In various tests, nanoscale polystyrene beads were introduced into fluidic chamber 208 as nanoparticles 602 and an AC electric field of about 83,333 volts per meter was generated between first electrode 202 and second electrode 204 (e.g., across fluidic chamber 208).The frequency of the AC electric field was tuned from about 10 kilohertz to about 3.5 kilohertz.

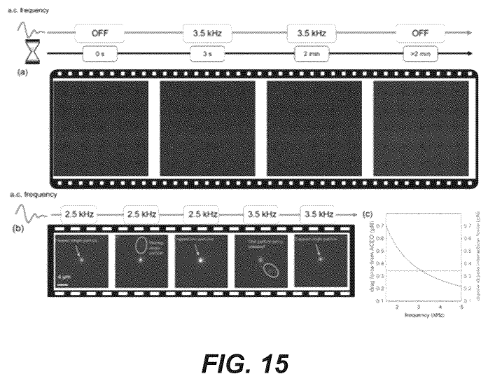

FIG. 15 illustrates frame-by-frame sequences of trapping of nanoparticles 602 at various AC frequencies. As illustrated in the top four frames of FIG. 15, applying the AC electric field at 3.5 kilohertz resulted in the fast parallelized transport of the single nanoparticles 602 towards each trap (for example, defined by each central region 212). As shown in the top four frames of FIG. 15, the nanoparticles 602 are rapidly trapped at the center of each trap when the AC electric field is applied, and rapidly released when the AC electric field is turned off. These results demonstrate that nanotweezer device 104 can rapidly transport and trap single nanoparticles 602 in parallel within seconds without relying on slow Brownian diffusion. In some embodiments, to achieve self-limiting single particle solution trapping, the interplay between the in-plane drag force from the alternating current electro-osmotic flows and the dipole-dipole repulsion force between nanoparticles 602 may be harnessed. For example, the graph at the bottom-right region of FIG. 15 illustrates a comparison between the dipole-dipole repulsion force between nanoparticles 602 (the straight line) and the drag force from the alternating current electro-osmotic flow (the curved line). In examples where central region 212 has a diameter of about 4 micrometers and the frequency of the AC electric field is above 3.5 kilohertz, the dipole-dipole repulsion force overcomes the drag field from the alternating current electro-osmotic flow.

The bottom five frames of FIG. 15 show the trapping of two particles in a single trap (defined by a single central region 212) when an AC electric field at 2.5 kilohertz is generated at nanotweezer device 104. When an AC electric field at 2.5 kilohertz is applied, each central region 212 may trap two nanoparticles 602. However, when the frequency of the AC electric field is increased to 3.5 kilohertz, the dipole-dipole repulsion force between nanoparticles 602 results in the repulsion of the second particle from the central region 212, which ensures that only a single nanoparticle 602 is trapped at each central region 212. In various implementations, the geometry of the nanohole array can be optimized to boost the imaging of trapped nanoparticles. For example, the optimal periodicity of the nanohole array may boost the fluorescence emission by 310% relative to the unoptimized system by beaming the photons upward for efficient collection.

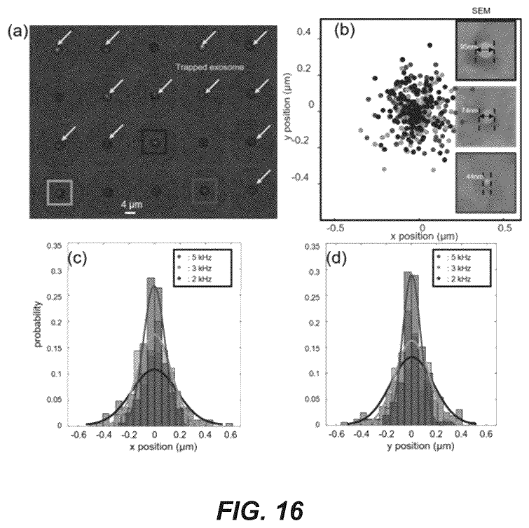

FIG. 16 illustrates the behavior of nanoparticles 602 trapped in parallel across an example implementation of nanotweezer device 104. Arrows in image (a) of FIG. 16 annotate locations of nanoparticles 602 trapped at central regions 212 when a 3.5 kilohertz AC electric field is generated at nanotweezer device 104. Scatterplot (b) of FIG. 16 shows the displacement of trapped nanoparticles 602 in x- and y-directions along the planar surface of second electrode 204. As shown in scatterplot (b) of FIG. 16, central regions 212 may trap nanoparticles 602 with a similar trapping stability along the x- and y-directions. This behavior may be expected because of the symmetric circular geometries of nanoholes 210 arranged around central regions 212 in some examples of second electrode 204. In examples where a 2.5 kilohertz AC electric field is generated at nanotweezer device 104, each trap at each central region 212 may exhibit a higher trapping stability than examples with a 3.5 kilohertz AC electric field. This may be because the particle-surface interaction force is stranger as the AC electric field frequency is reduced (since the double layer charges have sufficient time to be polarized by the applied AC electric field).

Trapping stability may also be dependent on the size of nanoparticles 602. For example, at any given field frequency, larger nanoparticles 602 (such as 95 nanometer extracellular vesicles) exhibit a higher trapping stability than smaller nanoparticles 602 (such as 44 nanometer extracellular vesicles). This increase in stability may be seen in the scanning electron microscope images shown in scatterplot (b) of FIG. 16. In some embodiments, after individual nanoparticles 602 are trapped in parallel at individual central regions 212, the frequency of the AC electric field may be reduced to a lower frequency, such as about 100 hertz, which “prints” the individual trapped nanoparticles 602 in position with a higher level of stability. The low frequency AC electric field results in an electrophoretic force that presses the nanoparticles 602 to the surface of nanotweezer device 104 so that van der Waals forces permanently holds the nanoparticles 602 in place. In some examples, nanoparticles 602 may remain in place even after the low frequency AC electric field is removed.

Histograms (c) and (d) of FIG. 16 illustrate lateral displacements of a trapped 44 nanometer nanoparticle 602 along the x- and y-directions, respectively. As illustrated in histograms (c) and (d), in some embodiments, nanoparticle 602 may be trapped more stably when a 2 kilohertz AC electric field is applied than when a 3 kilohertz AC electric field is applied, and more stably when a 3 kilohertz AC electric field is applied than when a 5 kilohertz AC electric field is applied.

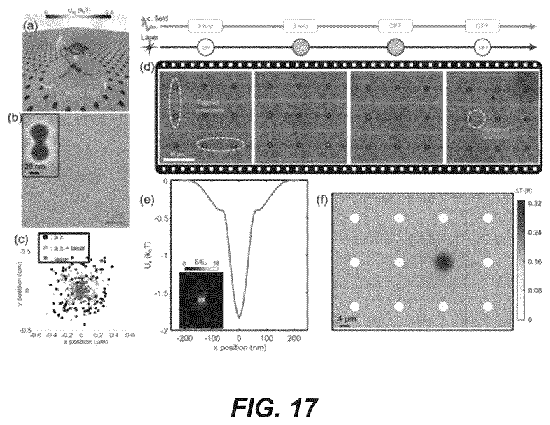

FIG. 17 illustrates behaviors of trapped nanoparticles 602 in response to AC electric fields being generated at nanotweezer device 104 and plasmonic cavities 802 being illuminated with laser 804. Scatterplot (c) of FIG. 17 shows the trapping stability for a single trapped exosome when: (i) the AC electric field is on (e.g., an electrohydrodynamic trapping mode), (ii) both the AC electric field and the laser are on, and (iii) when only the laser is on (e.g., a plasmonic trapping mode). Image (d) of FIG. 17 illustrates a frame-by-frame sequence of the trapping and release of an exosome using the superposition of electrohydrodynamic and plasmon-enhanced optical trapping potential upon laser illumination (e.g., with a laser spot size of about 1.6 micrometers). In the first frame, the single nanoparticles 602 (e.g., exosomes) are positioned at the center of central regions 212 near plasmonic cavities 802 and are held in place by the electrohydrodynamic potential. In the second frame, a single plasmonic cavity 802 is illuminated by laser 804. In the third frame, the AC electric field is switched off while the plasmonic cavity 802 remains illuminated by laser 804. As illustrated in the third frame, only the nanoparticle 602 trapped at the plasmonic cavity 802 illuminated by laser 804 remains trapped, while the other nanoparticles are released. In the fourth frame, both the laser and AC electric fields are switched off, allowing the trapped nanoparticle 602 to be released.

Inset (a) of FIG. 17 illustrates examples of a plasmonic cavity 802 formed as a double nanohole aperture in a gold film at a central region 212. Inset (b) of FIG. 17 is a scanning electron microscope image of an example of a plasmonic cavity 802 formed as a double nanohole aperture. Inset (f) of FIG. 17 shows a local temperature rise of about 0.32 kelvin at a plasmonic cavity 802 illuminated with laser 804 having a trapping intensity of 3.2×10⁹ watts per square meter (at a laser power of 6.3 milliwatts). Inset (e) of FIG. 17 shows a simulated optical trapping potential on a 100-nanometer diameter exosome.

In some examples, the trapping and imaging were performed using a custom fluorescent imaging and optical trapping microscope based on a Nikon ECLIPSE Ti2-E inverted microscope. The suspended particle solution was injected into the microfluidic channel. A high-quantum-efficiency sCMOS camera (the Prime 95B camera available from Teledyne Photometrics) was used to acquire images. The plasmonic double nanohole antenna was excited with a 973-nanometer semiconductor diode laser (the CLD1015 laser available from Thorlabs Inc.). The laser beam was focused with a 40× objective lens (0.75 numerical aperture) from Nikon Instruments Inc. The AC electric field was supplied by a dual-channel function generator (the Model 4047B available from B&K Precision Corporation).

In some examples, the trapping was validated using electromagnetic simulation. The electromagnetic simulation was performed using a full-wave simulation formalism in the Lumerical FDTD simulation software available from Ansys. Perfectly matched layers were placed at the top and bottom of the domain to prevent backscatter from boundaries. A linearly polarized plane wave served as the light source. A 3D COMSOL model was established to solve the heat transfer and fluid dynamics problem. A prescribed temperature of 293.15 kelvin was set at the boundaries for solving the heat transfer physics. The AC electro-osmosis flow was modeled by applying a slip boundary condition on the surface of the nanohole array. The slip velocity is the electro-osmotic slip velocity [symbol] , which is given by:

$$\vec{u} = {μ}_{eo} \vec{{E}_{t}} , where {μ}_{eo} = - \frac{{ε}_{r} {ε}_{0} ζ}{μ}$$

is the electro-osmotic mobility, and εᵣ is the relative permittivity. ε₀ is the permittivity of free-space, ζ is the zeta potential, and μ is the dynamic viscosity of the liquid. [symbol] = [symbol] − [symbol] · [symbol] ) [symbol] and [symbol] are calculated by solving Poisson's equation. The zeta potential used was calculated from the measured values, as described in the supplementary information. The no-slip boundary condition, which is u=0 was set on all other boundaries. The thermal properties of glass, gold, and water were adapted from the COMSOL material library. The relative permittivity of water at AC frequencies was set as 78.

Components of system 100—collectively or individually—combine to achieve a variety of new technical effects. For example, nanotweezer devices 104 are able to precisely trap individual nanoparticles 602 within seconds (as opposed to previous processes, which may take an hour or more). Trapped nanoparticles 602 may then be analyzed at an individual level of resolution (since each central region 212 is capable of trapping an individual nanoparticle 602) using techniques such as enhanced fluorescence, spectroscopy, and/or enhanced Raman spectroscopy. This dramatic increase in trapping throughput and resolution opens opportunities in many fields. For example, system 100 may be used in rapid liquid biopsy processes for the early detection of cancer and in monitoring patient responses to treatment. System 100 may also be used by medical professionals to analyze blood or tissue samples of patients. Furthermore, system 100 may be useful for fundamental research in understanding the heterogeneity of extracellular vesicles and extracellular particles—which has remained elusive to date.

Furthermore, system 100 enables the implementation of a variety of applications including (i) the high-throughput parallel trapping and enhanced spectroscopy of a heterogeneous population of nanosized extracellular vesicles with single-particle selectivity for study of the heterogeneity of extracellular vesicles, (ii) ultra-low detection limit nanotweezer diagnostics for the liquid biopsy of extracellular vesicles for early cancer detection and longitudinal patient monitoring, (iii) multifunctional optofluidic molecular selectors for selecting particles of interest post-characterization, and (iv) nanotweezer cytometry for profile size and molecular markers of single trapped extracellular vesicles.

System 100 may be used in applications beyond extracellular vesicle analysis as well. For example, system 100 may be used for the trapping and analysis of nanoplastics to study the biochemical properties and fates of nanoplastics in various environments. Additionally, in quantum photonics, system 100 may be used for the parallel placement of multiple quantum emitters. The integration of quantum emitters with plasmonic cavities 802 may be used to engineer the emission properties of quantum emitters (for example, the generation of high-purity entangled photon pairs and the realization of arrays of multiple indistinguishable single photon sources).

In addition to being able to precisely place any number of individual nanoparticles 602 near individual discrete corresponding traps at central regions 212 and/or at plasmonic cavities 802, nanotweezer devices 104 may be used to enhance Raman or fluorescence signals from single trapped extracellular vesicles and/or to rapidly deliver extracellular vesicles to functionalized surfaces to enrich specific molecules from biofluids and achieve the early diagnosis of diseases such as cancer. Additionally, nanotweezer devices 104 may be used to non-invasively monitor the response of patients to treatment. With respect to the liquid biopsy of extracellular vesicles for early cancer detection and patient monitoring, system 100 offers technical improvements by greatly increasing the speed with which analytes (such as extracellular vesicles or other nanoparticles 602) can be captured and analyzed. This dramatically lowers the limits at which nanoparticles 602 can be detected. Furthermore, system 100 can trap and analyze even the smallest of extracellular vesicles and/or particles (such as exomeres and supermeres), which may not be trappable using conventional technologies.

The foregoing description is merely illustrative in nature and does not limit the scope of the disclosure or its applications. The broad teachings of the disclosure may be implemented in many different ways. While the disclosure includes some particular examples, other modifications will become apparent upon a study of the drawings, the text of this specification, and the following claims. In the written description and the claims, one or more steps within any given method may be executed in a different order—or steps may be executed concurrently—without altering the principles of this disclosure. Similarly, instructions stored in a non-transitory computer-readable medium may be executed in a different order—or concurrently—without altering the principles of this disclosure. Unless otherwise indicated, the numbering or other labeling of instructions or method steps is done for convenient reference and does not necessarily indicate a fixed sequencing or ordering.

Unless the context of their usage unambiguously indicates otherwise, the articles “a,” “an,” and “the” should not be interpreted to mean “only one.” Rather, these articles should be interpreted to mean “at least one” or “one or more.” Likewise, when the terms “the” or “said” are used to refer to a noun previously introduced by the indefinite article “a” or “an,” the terms “the” or “said” should similarly be interpreted to mean “at least one” or “one or more” unless the context of their usage unambiguously indicates otherwise. Terms of degree, such as “substantially,” “about,” “approximately,” etc. are understood by those of ordinary skill to refer to reasonable ranges outside of the given value, for example, general tolerances associated with manufacturing, assembly, and use of the described aspects.

Spatial and functional relationships between elements—such as modules—are described using terms such as (but not limited to) “connected,” “engaged,” “interfaced,” and/or “coupled.” Unless explicitly described as being “direct,” relationships between elements may be direct or include intervening elements. The phrase “at least one of A, B, and C” should be construed to indicate a logical relationship (A OR B OR C), where OR is a non-exclusive logical OR, and should not be construed to mean “at least one of A, at least one of B, and at least one of C.” The term “set” does not necessarily exclude the empty set. For example, the term “set” may have zero elements. The term “subset” does not necessarily require a proper subset. For example, a “subset” of set A may be coextensive with set A, or include elements of set A. Furthermore, the term “subset” does not necessarily exclude the empty set.

In the figures, the directions of arrows generally demonstrate the flow of information—such as data or instructions. However, the direction of an arrow does not imply that information is not being transmitted in the reverse direction. For example, when information is sent from a first element to a second element, the arrow may point from the first element to the second element. However, the second element may send requests for data to the first element, and/or acknowledgements of receipt of information to the first element.

Throughout this application, the term “module” or the term “controller” may be replaced with the term “circuit.” A “module” may refer to, be part of, or include processor hardware that executes code and memory hardware that stores code executed by the processor hardware. The term “module” may include one or more interference circuits. In various implementations, the interference circuits may implement wired or wireless interfaces that connect to or are part of communications systems. Modules may communicate with other modules using the interference circuits. In various implementations, the functionality of modules may be distributed among multiple modules that are connected via communications systems. For example, functionality may be distributed across multiple modules by a load balancing system. In various implementations, the functionality of modules may be split between multiple computing platforms connected by communications systems.

The term “code” may include software, firmware, and/or microcode, and may refer to programs, routines, functions, classes, data structures, and/or data objects. The term “memory hardware” may be a subset of the term “computer-readable medium.” The term computer-readable medium does not encompass transitory electrical or electromagnetic signals or electromagnetic signals propagating through a medium—such as on an electromagnetic carrier wave. The term “computer-readable medium” is considered tangible and non-transitory. Modules, methods, and apparatuses described in this application may be partially or fully implemented by a special-purpose computer that is created by configuring a general-purpose computer to execute one or more particular functions described in computer programs. The functional blocks, flowchart elements, and message sequence charts described above serve as software specifications that can be translated into computer programs by the routine work of a skilled technician or programmer.

It should also be understood that although certain drawings illustrate hardware and software as being located within particular devices, these depictions are for illustrative purposes only. In some embodiments, the illustrated components may be combined or divided into separate software, firmware, and/or hardware. For example, instead of being located within and performed by a single electronic processor, logic and processing may be distributed among multiple electronic processors. Regardless of how they are combined or divided, hardware and software components may be located on the same computing device, or they may be distributed among different computing devices—such as computing devices interconnected by one or more networks or other communications systems.

In the claims, if an apparatus or system is claimed as including an electronic processor or other element configured in a certain manner, the claim or claimed element should be interpreted as meaning one or more electronic processors (or other element as appropriate). If the electronic processor (or other element) is described as being configured to make one or more determinations or one or execute one or more steps, the claim should be interpreted to mean that any combination of the one or more electronic processors (or any combination of the one or more other elements) may be configured to execute any combination of the one or more determinations (or one or more steps).

What is claimed is:

1. A nanotweezer comprising:
a first electrode;
a second electrode including a central region surrounded by a plurality of nanoholes;
a fluidic chamber between the first electrode and the second electrode; and
a voltage source configured to generate an electric field between the first electrode and the second electrode.

2. The nanotweezer of claim 1, wherein the plurality of nanoholes includes a circular array of nanoholes surrounding the central region.

3. The nanotweezer of claim 2, wherein the circular array of nanoholes includes nanoholes arranged in concentric circles around the central region.

4. The nanotweezer of claim 3, wherein the plurality of nanoholes includes a square array of nanoholes surrounding the circular array of nanoholes.

5. The nanotweezer of claim 1, further including:
a plasmonic nanocavity formed through the central region; and
a light source configured to illuminate the plasmonic nanocavity with a coherent focused light beam.

6. The nanotweezer of claim 5, wherein the voltage source is configured to stop generating the electric field after the light source illuminates the plasmonic nanocavity with the coherent focused light beam.

7. The nanotweezer of claim 5, wherein the voltage source is configured to reduce a frequency of the electric field after the light source illuminates the plasmonic nanocavity with the coherent focused light beam.

8. The nanotweezer of claim 7, wherein:
the light source is configured to stop illuminating the plasmonic nanocavity with the coherent light beam after the voltage source reduces the frequency of the electric field; and
the voltage source is configured to stop generating the electric field after the light source stops illuminating the plasmonic nanocavity with the coherent light beam.

9. The nanotweezer of claim 5, wherein the voltage source is configured to switch the electric field from an alternating current electric field to a direct current electric field after the light source illuminates the plasmonic nanocavity with the coherent focused light beam.

10. The nanotweezer of claim 1, wherein:
the second electrode includes a plurality of central regions surrounded by a plurality of nanoholes;
each central region is surrounded by a first plurality of nanoholes arranged in concentric circles around each central region; and
a second plurality of nanoholes is arranged in a square array around the first plurality of nanoholes.

11. A method of operating a nanotweezer including:
generating an electric field between a first electrode and a second electrode;
wherein the second electrode includes a central region surrounded by a plurality of nanoholes; and
wherein a fluidic chamber is defined between the first electrode and the second electrode.

12. The method of claim 11, wherein the plurality of nanoholes includes a circular array of nanoholes surrounding the central regions.

13. The method of claim 12, wherein the circular array of nanoholes includes nanoholes arranged in concentric circles around the central region.

14. The method of claim 13, wherein the plurality of nanoholes includes a square array of nanoholes surrounding the circular array of nanoholes.

15. The method of 11, further comprising illuminating a plasmonic nanocavity formed through the central region with a coherent focused light beam.

16. The method of claim 15, further comprising stopping the generation of the electric field after illuminating the plasmonic nanocavity with the coherent focused light beam.

17. The method of claim 15, further comprising reducing a frequency of the electric field after illuminating the plasmonic nanocavity with the coherent focused light beam.

18. The method of claim 17, further comprising:
stopping the illumination of the plasmonic nanocavity with the coherent light beam after reducing the frequency of electric field; and
stopping the generation of the electric field after stopping the illumination of the plasmonic nanocavity with the coherent light beam.

19. The method of claim 15, further comprising switching the electric field from an alternating current electric field to a direct current electric field after illuminating the plasmonic nanocavity with the coherent focused light beam.

20. The method of claim 11, wherein:
the second electrode includes a plurality of central regions surrounded by a plurality of nanoholes;
each central region is surrounded by a first plurality of nanoholes arranged in concentric circles around each central region; and
a second plurality of nanoholes is arranged in a square array around the first plurality of nanoholes.
